(19) United States
(12) Patent Application Publication
(10) Pub. No.: US 2014/0289809 A1
(43) Pub. Date: Sep. 25, 2014

(54) Cell-Phone-and Watermark-Dependent Authentication

(71) Applicants: Jason Arthur Taylor, Kensington, MD (US); Rebecca Ann Zeltinger, Kensington, MD (US)

(72) Inventors: Jason Arthur Taylor, Kensington, MD (US); Rebecca Ann Zeltinger, Kensington, MD (US)

(21) Appl. No.: 14/218,900

(22) Filed: Mar. 18, 2014

Related U.S. Application Data
(60) Provisional application No. 61/802,189, filed on Mar. 15, 2013.
(60) Provisional application No. 61/802,189, filed on Mar. 15, 2013.

(51) Int. Cl. H04W 12/06

(52) U.S. Cl. CPC H04W 12/06
USPC 726/4

(57) ABSTRACT

An improved authentication system is disclosed. In one class of embodiments, the system utilizes the distance between a user's cell phone and client's computer as an authenticating factor in an access control mechanism. Users attempting to log on to a system without their cell phone being nearby are granted low or zero usage rights, while users attempting to log on to a system when their cell phone is nearby are granted high or full rights. In some embodiments, an image that contains encoded information unique to that company's website is served to the user for use in verifying the authenticity of a website. In a class of embodiments, the system is programmed to restrict access if a correct response to a cryptographic authentication challenge is not provided. A non-binary authentication system is also disclosed. This non-binary system allows users to have partial access to a system.

### RELATED APPLICATIONS

This application claims priority to and benefit of U.S. Provisional Patent Application Ser. No. 61/802,189, filed either on Mar. 15, 2013 or Mar. 16, 2013, hereby incorporated by reference.

An 893-page document named “2all-rejected by pto.pdf” and “2a11.pdf” having an MD5 hash of 7a271c60be78e0f42alad30d07fcdbdd2e5933b8 (or '3b8) was electronically delivered to the USPTO on Mar. 15, 2013 EDT. A 447-page document named 1-4fromwordportrait2xfittoletter.pdf, having a SHAT hash of 65a3677392b5540f62238e768f6583c52f66aee6 was also electronically delivered to the USPTO on Mar. 15, 2013. Both files were created without edits from a Microsoft Word file having a SHA1 hash of C0168e4b165192348a36b522f423e793455a45db. A third 433-page document was electronically submitted as three files, specificationpart1fixed.pdf, specificationpart2.pdf, and specificationpart3.pdf having SHA1 hashes of 9b0e214e8b372174e20df59b22626d94cd6898bc, fb6ae51 a68eaa1fefc039095f7731 fe852d61381, a6b4d7c1e2fb9e91760f0a235ace97c891ba6ed2 to the USPTO on Mar. 15, 2013. It was also physically delivered on Mar. 15, 2013, but was dated Mar. 18, 2013. It was scanned as “Specification” and stamped “BEST COPY AVAILABLE” in the U.S. Provisional Patent Application Ser. No. 61/802,189 IFW. These documents are also hereby incorporated by reference unless doing so would alter this application's priority date or examination process (AIA vs. pre-AIA). Due to a combination of factors, including the extreme slowness of the EFS-Web system on Mar. 15, 2013, the unusually large size of the instant disclosure, certain errors in the USPTO's EFS-Web documentation, and the fact that the USPTO Customer Service Window closed one hour earlier than advertised, a petition was submitted requesting one or more of these documents be considered as part of the 61/802,189 disclosure.

### BACKGROUND OF THE INVENTION

1. Field of the Invention

The field of this class of inventions is authentication.

2. Background Art

In computing, e-Business, and information security, it is necessary to ensure that the data, transactions, communications or documents (electronic or physical) are genuine. For authenticity it is also important to validate that both parties involved are who they claim to be. Information security is the practice of defending information from unauthorized access, use, disclosure, disruption, modification, perusal, inspection, recording or destruction. Computer security is information security as applied to computers and networks. The field covers all the processes and mechanisms by which computer-based equipment, information, and services are protected from unintended or unauthorized access, change or destruction. Two-factor authentication seeks to decrease the probability that a requestor is presenting false evidence of its identity. Access to protected information must be restricted to people who are authorized to access the information. The computer programs, and in many cases the computers that process the information, must also be authorized. This requires that mechanisms be in place to control the access to protected information. The foundation on which access control mechanisms are built start with identification and authentication.

Identification is an assertion of who someone is or what something is. If a person makes the statement “Hello, my name is John Doe” they are making a claim of who they are. However, their claim may or may not be true. Before John Doe can be granted access to protected information it would be necessary to verify that the person claiming to be John Doe really is John Doe.

Authentication is the act of verifying a claim of identity. When John Doe goes into a bank to make a withdrawal, he tells the bank teller he is John Doe—a claim of identity. The bank teller asks to see a photo ID, so he hands the teller his driver's license. The bank teller checks the license to make sure it has John Doe printed on it and compares the photograph on the license against the person claiming to be John Doe. If the photo and name match the person, then the teller has authenticated that John Doe is who he claimed to be.

The three different types of information that can be used for authentication are something one knows (e.g., a password), has (e.g., a driver's license), or is (e.g., a fingerprint). Strong authentication requires providing more than one type of authentication information (two-factor authentication). The username is the most common form of identification on computer systems today and the password is the most common form of authentication.

3-D Secure is an XML-based protocol designed to be an additional security layer for online credit and debit card transactions. It was developed by Visa with the intention of improving the security of Internet payments and offered to customers as the Verified by Visa service. The intention behind 3-D Secure is that cardholders will have a decreased risk of other people being able to use their payment cards fraudulently on the Internet. The issuing bank or its ACS provider may prompt the buyer for a password that is known only to the bank/ACS provider and the buyer. Since the merchant does not know this password and is not responsible for capturing it, it can be used by the issuing bank as evidence that the purchaser is indeed their cardholder.

DRM technologies enable content publishers to enforce their own access policies on content, like restrictions on copying or viewing. Common DRM techniques include restrictive licensing agreements in which the access to digital materials, copyright and public domain is controlled. Some restrictive licenses are imposed on consumers as a condition of entering a website or when downloading software. Some DRM techniques utilize encryption, scrambling of expressive material, and embedding of a tag. This is designed to control access and reproduction of online information. This includes backup copies for personal use.

Watermarking is the process of hiding digital information in a carrier signal; the hidden information should, but does not need to contain a relation to the carrier signal. Digital watermarks are used to verify the authenticity or integrity of the carrier signal or to show the identity of its owners. It is prominently used for tracing copyright infringements and for banknote authentication. Watermarks are used to identify ownership of the copyright of such signal. In 2004, Blythe and Fridrich disclosed a secure digital camera using lossless watermarking to embed a biometric identifier together with a cryptographic hash.

Usernames and passwords have served their purpose but in our modern world they are no longer adequate. Despite the above technologies, computer browsers can, e.g., “lie” to computer servers. Using the google.com website, one of the instant inventors could view images of books in the Microsoft's Internet Explorer World Wide Web computer browser, but not print them. However, a different browser, Firefox, could be rewritten to respond as if it were Internet Explorer. In other words, a software program that does not have the same, exact operational restrictions of Internet Explorer could masquerade as Internet Explorer and “lie” to a web server in order to bypass intended restrictions (i.e., printing), thus gaining unauthorized access to content or services.

### BRIEF SUMMARY OF THE INVENTION

An improved authentication system is disclosed. In one class of embodiments, the system utilizes the distance between a user's cell phone and client's computer as an authenticating factor in an access control mechanism. Users attempting to log on to a system without their cell phone being nearby are granted low or zero usage rights, while users attempting to log on to a system when their cell phone is nearby are granted high or full rights. In some embodiments, an image that contains encoded information unique to that company's website is served to the user for use in verifying the authenticity of a website. In a class of embodiments, the system is programmed to restrict access if a correct response to a cryptographic authentication challenge is not provided. A non-binary authentication system is also disclosed. This non-binary system allows users to have partial access to a system.

### DETAILED DESCRIPTION OF EMBODIMENTS

1. Components of Invention
   Access Control Mechanism

Two-factor authentication requires the use of two of the three authentication factors. Without the corroborating verification of both factors, authentication does not succeed. The number of factors is important, since more factors imply higher probabilities that the bearer of the identity evidence indeed holds that identity in another realm (e.g., computer system vs real life). Realistically, there are more variables to consider when establishing the relative assurance of truthfulness in an identity assertion than simply how many “factors” are used.

After a person, program or computer has successfully been identified and authenticated then it must be determined what informational resources they are permitted to access and what actions they will be allowed to perform (run, view, create, delete, or change). This is called authorization. Authorization to access information and other computing services begins with administrative policies and procedures. The policies prescribe what information and computing services can be accessed, by whom, and under what conditions. The access control mechanisms are then configured to enforce these policies.
Public-Key Infrastructure

Public-key cryptography is a cryptographic technique that enables users to securely communicate on an insecure public network, and reliably verify the identity of a user via digital signatures. A public-key infrastructure (PKI) is a system for the creation, storage, and distribution of digital certificates which are used to verify that a particular public key belongs to a certain entity. The PM creates digital certificates which map public keys to entities, securely stores these certificates in a central repository, and revokes them if needed. PKI is an arrangement that binds public keys with respective user identities by means of a certificate authority (CA). The user identity must be unique within each CA domain. The third-party Validation Authority (VA) can provide this information on behalf of CA. The binding is established through the registration and issuance process, which, depending on the level of assurance the binding has, may be carried out by software at a CA, or under human supervision. The PKI role that assures this binding is called the Registration Authority (RA). The RA ensures that the public key is bound to the individual to which it is assigned in a way that ensures non-repudiation.

A PKI consists of a certificate authority (CA) that both issues and verifies the digital certificates, a registration authority which verifies the identity of users requesting information from the CA, a central directory—i.e. a secure location in which to store and index keys, a certificate management system, and a certificate policy.

Broadly speaking, there are three approaches to certification: certificate authorities (CAs), web of trust (WoT), and simple public-key infrastructure (SPKI).

The primary role of the CA is to digitally sign and publish the public key bound to a given user. This is done using the CA's own private key, so that trust in the user key relies on one's trust in the validity of the CA's key. When the CA is a third-party separate from the user and the system, then it is called the Registration Authority (RA), which may or may not be separate from the CA.[8] The key-user binding is established, depending on the level of assurance the binding has, by software or under human supervision.

The term trusted third party (TTP) may also be used for certificate authority (CA). Moreover, PKI is itself often used as a synonym for a CA implementation.

Temporary certificates & single sign-on is an approach that involves a server that acts as an online certificate authority within a single sign-on system. A single sign-on server will issue digital certificates into the client system, but never stores them. Users can execute programs, etc. with the temporary certificate.

Web of trust is an alternative approach to the problem of public authentication of public-key information. It uses self-signed certificates and third party attestations of those certificates. The singular term “web of trust” does not imply the existence of a single web of trust, or common point of trust, but rather one of any number of potentially disjoint “webs of trust”. Examples of implementations of this approach are PGP (Pretty Good Privacy) and GnuPG (an implementation of OpenPGP, the standardized specification of PGP). Because PGP and implementations allow the use of e-mail digital signatures for self-publication of public-key information, it is relatively easy to implement one's own web of trust.

One of the benefits of the web of trust, such as in PGP, is that it can interoperate with a PKI CA fully trusted by all parties in a domain (such as an internal CA in a company) that is willing to guarantee certificates, as a trusted introducer. Only if the “web of trust” is completely trusted, and because of the nature of a web of trust, trusting one certificate is granting trust to all the certificates in that web. A PKI is only as valuable as the standards and practices that control the issuance of certificates and including PGP or a personally instituted web of trust could significantly degrade the trustability of that enterprise's or domain's implementation of PKI.

Simple public-key infrastructure (SPKI) is another alternative which does not deal with public authentication of public-key information. SPKI does not associate users with persons. SPKI does not use any notion of trust, as the verifier is also the issuer.

The public disclosure of both secure key exchange and asymmetric key algorithms in 1976 by Diffie, Hellman, Rivest, Shamir, and Adleman changed secure communications entirely. With the invention of the World Wide Web and its rapid spread, the need for authentication and secure communication became still more acute. Commercial reasons alone (e.g., e-commerce, on-line access to proprietary databases from Web browsers, etc.) were sufficient. SSL (‘https’ in Web URLs) includes key establishment, server authentication (prior to v3, one-way only), and so on. A PKI structure was thus created for Web users/sites wishing secure communications.
Cellular Phone Component

Cellular/mobile phone tracking refers to the attaining of the current position of a mobile phone, stationary or moving. In order to route calls to a phone, the cell towers listen for a signal sent from the phone and negotiate which tower is best able to communicate with the phone. Localization may occur either via multilateration of radio signals between (several) radio towers of the network and the phone, or simply via GPS. To locate the phone using multilateration of radio signals, it must emit at least the roaming signal to contact the next nearby antenna tower, but the process does not require an active call. GSM is based on the signal strength to nearby antenna masts. The technology of locating is based on measuring power levels and antenna patterns and uses the concept that a powered mobile phone always communicates wirelessly with one of the closest base stations, so knowledge of the location of the base station implies the cell phone is nearby.

Advanced systems determine the sector in which the mobile phone resides and roughly estimate also the distance to the base station. Localization-Based Systems can be broadly divided into network-based, handset-based, SIM-based, hybrid, and wifi. Qualified services may achieve a precision of down to 50 meters in urban areas where mobile traffic and density of antenna towers (base stations) is sufficiently high. Rural and desolate areas may see miles between base stations and therefore determine locations less precisely. GSM localization is the use of multilateration to determine the location of GSM mobile phones, or dedicated trackers, usually with the intent to locate the user.

A GPS navigation device is any device that receives Global Positioning System (GPS) signals for the purpose of determining the device's current location on Earth. Due in part to regulations encouraging mobile phone tracking, including E911, the majority of GPS receivers are built into mobile telephones, with varying degrees of coverage and user accessibility. Due to the popularity of GPS devices, privacy of the user becomes a subject of debate. This is because GPS devices can give geo-location information of the user.

Mobile signatures are electronic signatures that are created using a mobile device and rely on signature or certification services in a location independent telecommunication environment.
Bluetooth Component

Bluetooth, standardized as IEEE 802.15.1, is a wireless technology standard for exchanging data over short distances (using short-wavelength radio transmissions in the ISM band from 2400-2480 MHz) from fixed and mobile devices, creating personal area networks (PANs) with high levels of security. It is a system that allowing mobile phones to communicate with computers (e.g., PCs). It operates in the range of 2400-2483.5 MHz (including guard bands). The range is 100 meters, 30 meters, or 3 meters, for class 1, 2, and 3. Bluetooth is a packet-based protocol with a master-slave structure.

Every Bluetooth device has a unique 48-bit address. For security reasons it is necessary to be able to recognize specific devices and thus enable control over which devices are allowed to connect to a given Bluetooth device. At the same time, it is useful for Bluetooth devices to be able to establish a connection without user intervention (for example, as soon as they are in range).

To resolve this conflict, Bluetooth uses a process called bonding. A bond is created through a process called pairing. The pairing process is triggered either by a specific request from a user to create a bond (for example, the user explicitly requests to “Add a Bluetooth device”), or it is triggered automatically when connecting to a service where (for the first time) the identity of a device is required for security purposes.

Pairing often involves some level of user interaction; this user interaction is the basis for confirming the identity of the devices. In legacy pairing, each device must enter a PIN code; pairing is only successful if both devices enter the same PIN code. During the pairing process, the two devices involved establish a relationship by creating a shared secret known as a link key. If a link key is stored by both devices they are said to be paired or bonded. A device that wants to communicate only with a bonded device can cryptographically authenticate the identity of the other device, and, therefore, be sure that it is the same device it previously paired with. Once pairing successfully completes, a bond will have been formed between the two devices, enabling those two devices to connect to each other in the future without requiring the initial pairing process in order to confirm the identity of the devices.

A Bluetooth-enabled mobile phone is able to pair with many devices. The Windows XP, Vista, and 7 Bluetooth stacks support the following Bluetooth profiles natively: PAN, SPP, DUN, HID, and HCRP. Linux has two popular Bluetooth stacks called BlueZ and Affix.

Bluetooth protocols simplify the discovery and setup of services between devices. Bluetooth devices can advertise all of the services they provide. This makes using services easier because more of the security, network address and permission configuration can be automated than with many other network types. Unlike its predecessor, IrDA, which requires a separate adapter for each device, Bluetooth allows multiple devices to communicate with a computer over a single adapter.

Wi-Fi is a wireless version of a common wired Ethernet network, and requires configuration to set up shared resources, transmit files, and to set up audio links (for example, headsets and hands-free devices). Wi-Fi uses the same radio frequencies as Bluetooth, but with higher power, resulting in higher bit rates and better range from the base station.
Digital Watermarking Component

A digital watermark is a kind of marker covertly embedded in a noise-tolerant signal such as audio or image data. In digital watermarking, the signal may be audio, pictures, video, texts or 3D models. A signal may carry several different watermarks at the same time. Whereas steganography aims for imperceptibility to human senses, digital watermarking tries to control the robustness as top priority.

The signal where the watermark is to be embedded is called the host signal. A watermarking system is usually divided into three distinct steps, embedding, attack, and detection. In embedding, an algorithm accepts the host and the data to be embedded, and produces a watermarked signal. The watermarked digital signal is then transmitted or stored, usually transmitted to another person. If this person makes a modification, this is called an attack.

Detection (often called extraction) is an algorithm which is applied to the attacked signal to attempt to extract the watermark from it. If the signal was unmodified during transmission, then the watermark still is present and it may be extracted. In robust digital watermarking applications, the extraction algorithm should be able to produce the watermark correctly, even if the modifications were strong. In fragile digital watermarking, the extraction algorithm should fail if any change is made to the signal.

A digital watermark is called robust with respect to transformations if the embedded information may be detected reliably from the marked signal, even if degraded by any number of transformations. Typical image degradations are JPEG compression, rotation, cropping, additive noise, and quantization. For video content, temporal modifications and MPEG compression often are added to this list.

A digital watermark is called fragile if it fails to be detectable after the slightest modification. Fragile watermarks are commonly used for tamper detection (integrity proof). Modifications to an original work that clearly are noticeable, commonly are not referred to as watermarks, but as generalized barcodes. A digital watermark is called semi-fragile if it resists benign transformations, but fails detection after malignant transformations. Semi-fragile watermarks commonly are used to detect malignant transformations. A digital watermark is called robust if it resists a designated class of transformations.
2. Improved Authentication Embodiments

As a preliminary remark, in some embodiments, the invention utilizes an access control mechanism having a non-binary, variable authentication capability. In this case, the system is programmed to allow users to be assigned distinct authorities that allow access. This allows users to, e.g., “log on” to something with low authority or instead with complete control. In such embodiments, documents are, for example, readable at a low authority but not editable/writable, which requires a higher level of authentication.

An authentication system and access control mechanism comprises a user's computer, their potential cellular telephone, a webserver, and a network, such as the internet. In a class of embodiments, the location of a user's cell phone is used as one factor in a security system. In one embodiment, the location of the cell phone is determined from assisted GPS. In one class of embodiments, when a user attempts to log on to a computer, the computer computes the approximate distance between the position of the user's cell phone and the position of the computer. If that distance is very small, the access control mechanism assigns the user an authentication level associated with low risk (i.e., high access).

In some classes of embodiments, a user's cell phone is detected using near field communications, Bluetooth, infrared/IrDa light, etc. In some classes of embodiments, during an initial pairing process, the two unique devices involved establish a relationship by creating a link key. A bond will have been formed between the two unique devices, enabling those two devices to connect to each other in the future without requiring the initial pairing process in order to confirm the unique identity of the devices. In some classes of embodiments, the first time a user attempts to authenticate is different from the subsequent times, where (unlike the first authentication procedure), the invention merely needs to output the authentication level to the authentication-level-dependent services utilizing this information.

In some embodiments, depending on the adjustable settings, if a user who has already bonded their cell phone to their PC attempts to log on, but this time without their cell phone being detected nearby, that user is locked out.

In one class of embodiments, a key-exchange authentication system is used.

A class of embodiments tests subsystems to see if they have been modified. This system is known to those skilled in the art and is utilized in, e.g., hard-to-crack copy protection systems. A difference in the instant invention is that the two programs could be located, e.g., 1000 miles away from each other as they as pass encrypted packets over the internet.

In a class of embodiments, the authenticating system granting a level of access to a company's internet domain name is embedded into a non-trivial-to-read image. For example, if the user wishes to have access to the internet website, “Yahoo.com,” yahoo.com delivers a difficult-to-read image to the user's PC containing the watermark signal of “yahoo.com”. This information is compared to the intended website to ensure that the server is not performing “computerized dishonesty” (i.e., “lying”) to the user about it's subsystem. In other words, that the website server is, e.g., not actually at a website different than yahoo.com, such as a pornographic site merely masquerading as yahoo.com and that the internal subsystems are what was desired and expected by the user.

In a class of embodiments, the system is programmed such that unless a program can respond correctly to a cryptographic authentication challenge, full authentication is not granted. In such a case, the server is programmed to deny access to requested services (e.g., pictures or other DRM material).

In a class of embodiments, the watermark is time sensitive, such that there is an initial image, followed by a middle frame, followed by a final image. In a class of embodiments, this watermark is delivered in the form of an animated GIF file. In another class of embodiments, the “animation” is emulated.

While the present invention has been described in connection with what is considered the most practical and preferred embodiments, it is understood that this invention is not limited to the disclosed embodiments but is intended to cover various arrangements included within the spirit and scope of the broadest interpretations and equivalent arrangements.

1. (canceled)

2. A computer authentication method comprising a computer and a user's potential cellular telephone that is not the computer, wherein the method assigns an authentication level that is a function of the presence or absence of the user's potential cell phone.

3. The method of claim 2, wherein said function assigns a higher authentication rights level if the user's potential cellular phone is present than if it is absent.

4. The method of claim 3, wherein said presence or absence of a user's potential cell phone is determined by sending or receiving optical radiation between the potential cell phone and the computer.

5. The method of claim 4, wherein said optical radiation is further within the infra-red band.

6. The method of claim 3, wherein said presence or absence of the user's cell phone is obtained from wireless communication between the computer and the potential cell phone.

7. The method of claim 6, wherein the wireless communication uses Bluetooth.

8. The method of claim 7, wherein the reestablishment of an old Bluetooth connection is used to determine the presence of a user's potentially registered cell phone.

9. The method of claim 3, wherein said presence or absence of a user's potential cellular phone determination is made by estimating the distance between the user's potential cell phone and the computer.

10. The method of claim 9, wherein said distance is determined using assisted GPS.

11. The method of claim 10, wherein the user's potential cell phone is programmed to be absent if the distance between the PC and the registered cell phone exceeds 100 meters.

12. The method of claim 4, further comprising the computer displaying an image from a web server that is a unique function of the domain name of the web server that the user intends to access.

13. The method of claim 12, wherein the web server initiates a cryptographic challenge revealing the web server's authenticity to the client's computer.

14. The method of claim 3, wherein the authentication level assigned to a user with an absent cellular phone is such that not all access is denied.
